(19) United States
(12) Patent Application Publication
(10) Pub. No.: US 2007/0298347 A1
(43) Pub. Date: Dec. 27, 2007

(54) Liquid developer

(76) Inventors: Koji Iwase, Osaka-shi (JP); Itsuo Iwai, Osaka-shi (JP); Kenjiro Yai, Osaka-shi (JP)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/895,941

(22) Filed: Aug. 27, 2007

Related U.S. Application Data
(63) Continuation of application No. 11/040,983, filed on Jan. 21, 2005.

(51) Int. Cl. G03G 5/00

(52) U.S. Cl. 430/137.22

(57) ABSTRACT

A liquid developer composition for electrophotography is disclosed which comprises a pigment, an acrylic-based thermoplastic resin, an electric insulating solvent and a dispersant, the acrylic-based thermoplastic resin having a degree of swelling of less than 0.5 g against the electric insulating solvent, the dispersant comprising at least one of modified novolak resin (A) and copolymer (B) each of which contains in its molecule an aromatic ring and a structure given by ring opening of an epoxy group with a carboxyl group derived from a hydroxycarboxylic acid.

### BACKGROUND OF THE INVENTION

The present invention relates to a liquid developer for electrophotography or electrostatic recording which is used for a printing machine, a copy machine, a printer, a facsimile and the like.

As the liquid developer, there is used one wherein toner particles in which a colorant such as a pigment is covered with a thermoplastic resin are dispersed in an electric insulating solvent.

As the thermoplastic resin, there is used a thermoplastic resin which has a portion insoluble and a portion soluble in the electric insulating solvent in combination so that the toner particles exhibit good dispersion stability in the electric insulating solvent.

The high solidification of a liquid developer has been recently required from the viewpoints of the speed-up of developing speed, the increase of mileage and the recovery of the electric insulating solvent.

However, since the liquid developer using the above-mentioned thermoplastic resin is highly viscous, high solidification is difficult and further, development at high speed using the liquid developer causes such problems that staining in image portion and fogging and scumming in non image portion are generated.

Furthermore, the use of the above-mentioned liquid developer after dilution so that the fogging and scumming in non image portion are not generated causes such a problem that the density unevenness of image portion is generated.

In view of the foregoing, an object of the present invention is to provide a liquid developer for electrophotography or electrostatic recording which is capable of being highly solidified and is excellent in high speed developing property.

The foregoing and other objects of the present invention will be apparent from the following description.

### SUMMARY OF THE INVENTION

The present inventors have variously studied liquid developers, and as a result, have found that a liquid developer which is capable of being highly solidified and is excellent in high speed developing property can be obtained by using an acrylic-based thermoplastic resin having a degree of swelling of less than 0.5 g against an electric insulating solvent and a specific pigment dispersant, resulting in the completion of the present invention.

The present invention provides a liquid developer composition comprising a pigment, an acrylic-based thermoplastic resin, an electric insulating solvent and a dispersant, the acrylic-based thermoplastic resin having a degree of swelling of less than 0.5 g against the electric insulating solvent, the dispersant comprising at least one of modified novolak resin (A) and copolymer (B).

Modified novolak resin (A): a modified novolak resin containing in its molecule an aromatic ring derived from a novolak resin and at least one group represented by general formula (1) obtained by ring opening of an epoxy group with a carboxyl group derived from a hydroxycarboxylic acid, 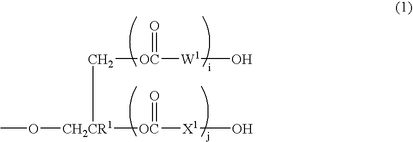
wherein the oxygen atom at the left end is derived from an oxygen atom contained in a phenolic hydroxyl group of the novolak resin; W¹ and X¹ represent independently a divalent hydrocarbon group having 1 to 19 carbon atoms; i and j represent independently integers of i=1 to 30 and j=0 to 30; and R¹ represents a hydrogen atom or a methyl group.

Copolymer (B): a copolymer having a weight average molecular weight of 3,000 to 100,000 which contains an amount equivalent to at least 10% by mole of a recurring unit represented by general formula (2) and an amount equivalent to at least 10 % by mole of at least one recurring unit selected from the group consisting of recurring units represented by general formula (3) and general formula (4), 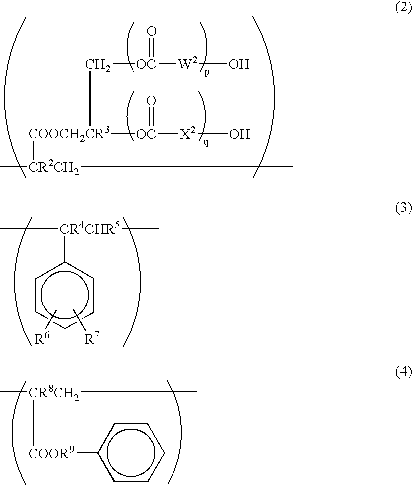
wherein W² and X² represent independently a divalent hydrocarbon group having 1 to 19 carbon atoms; p and q represent independently integers of p=1 to 30 and q=0 to 30; R², R³ and R⁴ represent independently a hydrogen atom or a methyl group; R⁵ represents a hydrogen atom or a halogen atom; R⁶ and R⁷ represent independently a hydrogen atom, a hydrocarbon group having 1 to 5 carbon atoms, an alkoxy group having 1 to 5 carbon atoms, an aryloxy group having 6 to 10 carbon atoms or a halogen atom; R⁸ represents a hydrogen atom or a methyl group; and R⁹ represents a direct bond or a methylene group.

The copolymer (B) has a structure wherein relatively large side chain represented by general formula (2) dangle from the main chain, which structure appears in graft copolymers. From this viewpoint, the copolymer (B) may be referred to as “graft copolymer”.

### DETAILED DESCRIPTION

The liquid developer of the present invention will be more specifically explained.

The liquid developer of the present invention comprises a pigment, an acrylic-based thermoplastic resin, an electric insulating solvent, a dispersant and if necessary, a charge controlling agent. In the liquid developer of the present invention, the pigment and the acrylic-based thermoplastic resin can exist in various modes depending upon the preparation method. In general, however, the pigment and the acrylic-based thermoplastic resin exist in the form of toner particles having a structure in which one or more pigment particles are substantially covered with the acrylic-based thermoplastic resin, and said toner particles are dispersed in an electric insulating solvent. From the viewpoint of producing high-accuracy images, the toner particles preferably have an average particle size of not more than 4 μm, especially from 0.5 to 3 μm. From the viewpoint of high solidification, the content of the toner particles in the liquid developer of the present invention is preferably from 1 to 50 % by weight, more preferably from 1 to 40 % by weight.

Inorganic pigments and organic pigments can be used as the pigment in the present invention. Inorganic pigments such as acetylene black, graphite, iron oxide red, chrome yellow, ultramarine blue and carbon black, and organic pigments such as an azo pigment, a lake pigment, a phthalocyanine pigment, an isoindoline pigment, an anthraquinone pigment and a quinacridone pigment are preferable.

The content of the pigment in the liquid developer of the present invention is not specifically limited, but it is preferably 1 to 30 parts by weight on the basis of 100 parts by weight of the finished liquid developer from the viewpoint of image density.

The acrylic-based thermoplastic resin used in the present invention is one having a degree of swelling of less than 0.5 g against an electric insulating solvent in the liquid developer. The degree of swelling of the acrylic-based thermoplastic resin in the present invention is a characteristic value determined as follows:

Firstly, 1 g of an acrylic-based thermoplastic resin is added to 20 g of an electric insulating solvent which is used in the liquid developer and a solvent with a low boiling point capable of dissolving the acrylic-based thermoplastic resin (e.g. tetrahydrofuran or the like) is added under stirring until the acrylic-based thermoplastic resin is dissolved. The solvent with a low boiling point capable of dissolving the acrylic-based thermoplastic resin is completely distilled off under a reduced pressure to precipitate the acrylic-based thermoplastic resin. Then, centrifugal separation is carried out at 3,000 G for 30 minutes to sediment the acrylic-based thermoplastic resin. The supernatant is discarded and the precipitate is taken out. The weight of the precipitate is measured. The weight of the electric insulating solvent contained in the resin obtained according to the formula: [Weight of precipitate−Weight (1 g) of acrylic-based thermoplastic resin] is referred to as the degree of swelling. Consequently the degree of swelling in the present invention is represented as the maximum weight of the electric insulating solvent contained in 1 g of the acrylic-based thermoplastic resin.

When the degree of swelling of the acrylic-based thermoplastic resin is higher than 0.5 g, high solidification is difficult and the development at higher speed causes problems that the fogging and scumming in non image portion are generated.

As the acrylic-based thermoplastic resin used in he present invention, there are acrylic-based thermoplastic resins which are obtained by polymerizing at least one monomer appropriately selected from (meth)acrylic alkyl esters preferably with an alkyl group having 1 to 18 carbon atoms, such as methyl methacrylate, methyl acrylate, ethyl methacrylate, ethyl acrylate, isopropyl methacrylate, isopropyl acrylate, isobutyl methacrylate, isobutyl acrylate, lauryl methacrylate, lauryl acrylate, stearyl methacrylate, stearyl acrylate, 2-ethylhexyl methacrylate, 2-ethylhexyl acrylate, hexyl methacrylate, hexyl acrylate, octyl methacrylate, octyl acrylate, cetyl methacrylate, cetyl acrylate, nonyl methacrylate, nonyl acrylate, decyl methacrylate, decyl acrylate, cyclohexyl methacrylate and cyclohexyl acrylate, and, if necessary, at least one selected from the group consisting of styrene monomers, such as styrene, methylstyrene, ethylstyrene, chlorostyrene, bromostyrene, methoxystyrene and ethoxystyrene; other monomers having an aromatic ring, such as vinyl naphthalene, benzyl methacrylate and benzyl acrylate; monomers having an amino group (preferably (meth)acrylic monomers having an amino group), such as dimethyl acrylamide, diethyl acrylamide, 2-vinyl pyridine, acryloyl morpholine, N,N-dimethylaminoethyl (meth)acrylate and N,N-diethylaminoethyl (meth)acrylate; monomers having a hydroxyl group (preferably (meth)acrylic monomers having a hydroxyl group), such as hydroxyethyl methacrylate, hydroxyethyl acrylate, hydroxypropyl methacrylate and hydroxypropyl acrylate; and vinyl ethers, such as vinyl lauryl ether and vinyl stearyl ether, in such a manner that the degree of swelling against the electric insulating solvent is less than 0.5 g.

The electric insulating solvent used in the present invention is a solvent showing low dissolving power to the acrylic-based thermoplastic resin, and preferably at least one selected from the group consisting of aliphatic hydrocarbons, alicyclic hydrocarbons, aromatic hydrocarbons, halogenated hydrocarbons, polysiloxanes and a vegetable oils each of which is non-volatile or slightly volatile and has such a volume resistivity (about 10¹¹ to 10¹⁶ Ω·cm) that does not disturb a static latent image. Among these, normal paraffin solvent, isoparaffin solvent and liquid paraffin solvent are preferable from the viewpoints of odor, harmlessness and cost. Typical examples of the normal paraffin and isoparaffin solvents include Isopar G, Isopar H, Isopar L and Isopar M (all manufactured by Exxon Mobil Chemical Corporation), SHELLSOL 71 (manufactured by Shell Chemicals Limited), IP Solvent 1620 and IP Solvent 2080 (all manufactured by Idemitsu Petrochemical Co., Ltd.). The liquid developer of the present invention preferably has a volume resistivity of 10⁸ to 10¹⁶ Ω·cm, more preferably 10⁹ to 10¹⁶ Ω·cm.

The charge controlling agent used in the present invention is classified roughly into two types of (1) and (2) illustrated below.

Type (1):

The charge controlling agent of this type comprises a substance capable of ionizing or adsorbing ion, and the surface of toner particles is covered with the substance.

Preferable examples of the charge controlling agent of this type are oil and fats such as linseed oil and soybean oil, an alkyd resin, a halogenated polymer, an aromatic polycarboxylic acid, a water soluble dye containing an acidic group, and an oxidative condensed product of an aromatic polyamine.

Type (2):

The charge controlling agent of this type comprises a substance capable of giving and receiving ions with the toner particles and the substance is allowed to coexist in a state of being dissolved in the electric insulating solvent.

Preferable examples of the charge controlling agent of this type are metal soaps such as cobalt naphthenate, nickel naphthenate, iron naphthenate, zinc naphthenate, zirconium octylate (zirconium octanoate), cobalt octylate, nickel octylate, zinc octylate, cobalt dodecylate, nickel dodecylate, zinc dodecylate and cobalt 2-ethylhexylate; metal salts of sulfonic acid such as a metal salt of petroleum-based sulfonic acid and a metal salt of sulfosuccinic acid; phospholipids such as lecithin and cephalin; metal salts of salicylic acid such as a metal complex of t-butylsalicylic acid; a polyvinyl pyrrolidone resin, a polyamide resin, a sulfonic acid group-containing resin, and a hydroxybenzoic acid derivative.

The dispersant used in the present invention is effective for improving the dispersing property of toner particles, and specifically, comprises the below-mentioned modified novolak resin (A) and/or graft copolymer (B) each of which have an aromatic ring and a structure obtained by ring opening of an epoxy group with a carboxyl group derived from a hydroxycarboxylic acid and which are described in JP 09-302259 A in the name of the same applicant as in the present application.

Modified novolak resin (A): a modified novolak resin containing in its molecule an aromatic ring derived from a novolak resin and at least one group represented by general formula (1) obtained by ring opening of an epoxy group with a carboxyl group derived from a hydroxycarboxylic acid, 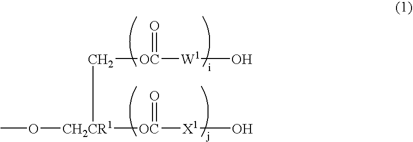
wherein the oxygen atom at the left end is derived from an oxygen atom contained in a phenolic hydroxyl group of the novolak resin; W¹ and X¹ represent independently a divalent hydrocarbon group having 1 to 19 carbon atoms; i and j represent independently integers of i=1 to 30 and j=0 to 30; and R¹ represents a hydrogen atom or a methyl group.

Graft copolymer (B): a copolymer having a weight average molecular weight of 3,000 to 100,000 which contains an amount equivalent to at least 10% by mole of a recurring unit represented by general formula (2) and an amount equivalent to at least 10% by mole of at least one recurring unit selected from the group consisting of recurring units represented by general formula (3) and general formula (4), 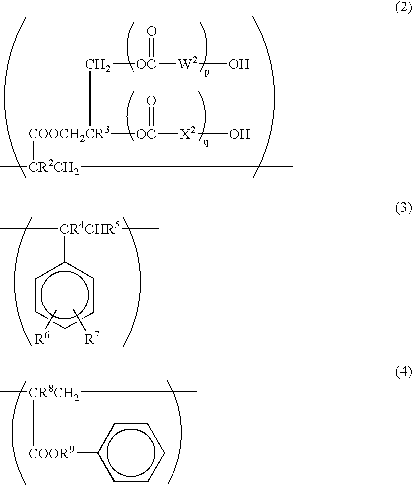
wherein W² and X² represent independently a divalent hydrocarbon group having 1 to 19 carbon atoms; p and q represent independently integers of p=1 to 30 and q=0 to 30; R², R³ and R⁴ represent independently a hydrogen atom or a methyl group; R⁵ represents a hydrogen atom or a halogen atom; R⁶ and R⁷ represent independently a hydrogen atom, a hydrocarbon group having 1 to 5 carbon atoms, an alkoxy group having 1 to 5 carbon atoms, an aryloxy group having 6 to 10 carbon atoms or a halogen atom; R⁸ represents a hydrogen atom or a methyl group; and R⁹ represents a direct bond or a methylene group.

The modified novolak resin in accordance with the present invention will first be described.

A novolak resin used for preparation of the modified novolak resin in accordance with the present invention is derived from an aldehyde and a monohydric phenol or a polyhydric phenol such as dihydroxybenzene or trihydroxybenzene. Examples of specific monohydric phenols include phenol (non-substituted phenol); and alkyl-substituted phenols such as cresol, xylenol, trimethylphenol, propylphenol, butylphenol, amylphenol, hexylphenol, octylphenol, nonylphenol and dodecylphenol; monohydroxydiphenylmethanes; and phenols having an aromatic substituent such as phenylphenol. Examples of specific polyhydric phenols include di- or trihydroxybenzenes such as catechol, resorcinol, hydroquinone and trihydroxybenzene, and alkyl or aryl derivatives of the forgoing di- or trihydroxybenzens; dihydroxydiphenylmethanes such as bisphenol A and bisphenol F; and dihydroxybiphenyls. Halo derivatives of the aforesaid phenols can also be used which include, for example, chlorinated phenols and brominated phenols. These phenols may be used either alone or as a mixture of two or more species thereof.

From the viewpoint of high reactivity, it is preferable to use phenol or a phenol with a single alkyl substituent at its meta position among the aforesaid monohydric phenols, or resorcinol among the aforesaid polyhydric phenols.

Usable as the aldehyde are those commonly used for production of novolak resins without particular limitation. Examples thereof include lower aliphatic aldehydes such as formaldehyde, paraformaldehyde, trioxane, cyclic formals, acetaldehyde, propionaldehyde, n-butylaldehyde, isobutylaldehyde and glyoxal; and aromatic aldehydes such as furfural and benzaldehyde. These aldehydes may be used either alone or as a mixture of two or more species thereof.

For synthesis of the novolak resin, a reaction of a phenol with an aldehyde is carried out at 80° to 130° C. in the presence of an acid catalyst such as p-toluenesulfonic acid, perchloric acid, hydrochloric acid, nitric acid, sulfuric acid, chloroacetic acid, oxalic acid or phosphoric acid by an ordinary method. The reaction may be followed by measuring the molecular weight by way of gel permeation chromatography (GPC).

The novolak resin may be synthesized from a phenol derivative having a hydroxymethyl group such as saligenin or from a phenol derivative having a halogenated methyl group such as o-chloromethylphenol.

The resulting novolak resin is reacted with epichlorohydrin and/or β-methylepichlorohydrin to provide a novolak resin having an epoxy group. Alternatively, a commercially available novolak resin having an epoxy group may be used.

The novolak resin having an epoxy group is reacted with a carboxylic acid or an amine (which will be described later) to give a modified novolak resin. This reaction can be conducted at 60° to 160° C., if necessary in a solvent, and if necessary in the presence of a catalyst such as an aliphatic amine, an aromatic amine or an ammonium salt. The reaction may be followed by measuring the molecular weight by way of GPC or by measuring the epoxy equivalent.

Alternatively, one or more phenolic hydroxyl groups of a monohydric or polyhydric phenol as described above is first reacted with epichlorohydrin and/or β-methylepichlorohydrin to give a glycidyloxy group and/or 2,3-epoxy-2-methylpropyloxy group, which is then reacted with a carboxylic acid or an amine which is to be described later. If necessary, another phenol is added to the reaction product, which is then reacted with an aldehyde to give a modified novolak resin (A) according to the present invention.

The group represented by formula (1) in the modified novolak resin (A) according to the present invention can be formed by reacting the phenolic hydroxyl group of the novolak -resin or phenol with epichlorohydrin and/or β-methylepichlorohydrin, and then with a hydroxycarboxylic acid having 2 to 20 carbon atoms and optionally having an unsaturated bond and/or a branched structure, a mixture of such hydroxycarboxylic acids or a polycondensation product of one or more such hydroxycarboxylic acids.

In general formula (1), the oxygen atom at the left end is derived from an oxygen atom of a phenolic hydroxyl group of the novolak resin; W¹ and X¹ each represent a divalent hydrocarbon group having 1 to 19 carbon atoms and optionally having an unsaturated bond and/or a branched structure; and R¹ represents a hydrogen atom or a methyl group.

In general formula (1), a group represented by general formula (5): 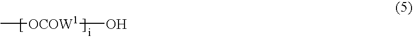
wherein W¹ and i each have the same definition as described above and a group represented by general formula (6): 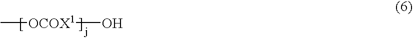
wherein X¹ and j each have the same definition as described above are derived from a hydroxycarboxylic acid having 2 to 20 carbon atoms and optionally having an unsaturated bond and/or a branched structure, or a mixture of such hydroxycarboxylic acids or a polycondensation product of one or more such hydroxycarboxylic acids.

Examples of specific hydroxycarboxylic acids include glycolic acid, lactic acid, hydroxybutyric acid, hydroxyvaleric acid, hydroxycaproic acid, hydroxycaprylic acid, hydroxycapric acid, hydroxylauric acid, hydroxymyristic acid, hydroxypalmitic acid, ricinolic acid and castor oil fatty acid and hydrogenated products of these unsaturated hydroxycarboxylic acids, and 12-hydroxystearic acid. Among these, hydroxycarboxylic acids having 12 to 20 carbon atoms, especially hydroxycarboxylic acids having 16 to 20 carbon atoms such as ricinolic acid and castor oil fatty acid, hydrogenated products thereof and 12-hydroxystearic acid are preferably used.

The repetition number i is an integer within the range of 1 to 30 and the repetition number j is an integer within the range of 0 to 30. The optimal repetition numbers vary depending on the type of a pigment to be used, the specific surface area and particle size of the pigment, the properties of a surface treating agent for the pigment, the type of a thermoplastic resin and the polarity of a dispersion medium, etc. Therefore, the repetition numbers should be optimized in each case. Generally, however, it is preferable that i or j≧2 and i+j≧2. If the repetition number i or j exceeds the aforesaid ranges, the dispersibility cannot be further improved.

The group represented by general formula (5) or (6) in general formula (1) can be formed, for example, by first carrying out polycondensation of a hydroxycarboxylic acid to form a polyester and then reacting its terminal carboxyl group with the aforesaid epoxy group, or, alternatively, by first reacting a carboxyl group of a hydroxycarboxylic acid with the aforesaid epoxy group and then further carrying out polycondensation of a hydroxycarboxylic acid.

The polycondensation of the hydroxycarboxylic acid can be conducted by heating the reaction system with stirring at 180° to 220° C. in the presence or absence of a catalyst such as p-toluenesulfonic acid, stannous octylate, dibutyltin diacetate or tetra-n-butyl titanate while generated water is removed with an azeotropic solvent such as toluene or xylene. The reaction can be followed by measuring the molecular weight by way of GPC or by measuring the acid value.

The modified novolak resin (A) according to the present invention must have the group represented by general formula (1) in a molecule thereof. The number of the groups represented by general formula (1) in a single molecule of the modified novolak resin is preferably in the range of 1 to 20. A novolak resin having no group represented by general formula (1) does not offer satisfactory dispersibility. Even if the number of the groups exceeds the aforesaid range, satisfactory effects may be offered, but it is very difficult to control the molecular weight of a novolak resin having a larger number of phenolic rings. In practice, the upper limit of the number of the phenolic rings is 20. The optimal number of the groups varies depending on the type of a pigment to be used, the specific surface area and particle size of the pigment, the presence or absence or the properties of a surface treating agent for the pigment, the type of a thermoplastic resin, the polarity of a dispersion medium to be used, and the like. Therefore, the number of the groups should be optimized in each case.

The modified novolak resin (A) according to the present invention may further contain, in its molecule, at least one the group represented by general formula (7): 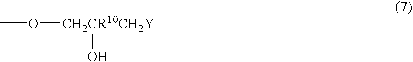
wherein the oxygen atom at the left end is derived from an oxygen atom of a phenolic hydroxyl group of the novolak resin; Y represents a monovalent organic group having 1 to 20 carbon atoms and, at its bonding end, an oxygen atom or a nitrogen atom (excluding the group represented by general formula (5)); and R¹⁰ represents a hydrogen atom or a methyl group.

The group represented by general formula (7) can be formed by reacting the phenolic hydroxyl group with epichlorohydrin and/or β-methylepichlorohydrin and then with a monocarboxylic acid or a monovalent amine. Since a basic group formed by the reaction with the monovalent amine tends to adversely affect on the charging property, it is better to avoid the use of the monovalent amine. If the monovalent amine is used, it is necessary to carefully determine the amount of the monovalent amine.

Examples of specific monocarboxylic acids include saturated fatty acids such as acetic acid, propionic acid, butyric acid, caproic acid, caprylic acid, capric acid, lauric acid, myristic acid, palmitic acid and stearic acid; unsaturated fatty acids such as oleic acid, elaidic acid, linolic acid, linolenic acid, arachidonic acid and eleostearic acid; and hydrogenated products of these unsaturated fatty acids.

Examples of specific monoamines include aliphatic primary monoamines such as methylamine, ethylamine, propylamine, butylamine, amylamine, octylamine, dodecylamine, stearylamine and benzylamine; aromatic primary monoamines such as aniline and naphthylamine; secondary monoamines derived from N-monoalkylation of these aliphatic and aromatic primary monoamines; alkanolmonoamines having a primary or secondary amino group such as ethanolamine, N-monoalkylethanolamine and diethanolamine.

The modified novolak resin (A) according to the present invention may further contain, in a molecule thereof, at least one group represented by general formula (8): 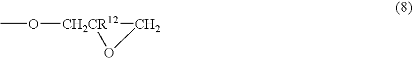
wherein the oxygen atom at the left end is derived from an oxygen atom of a phenolic hydroxyl group of the novolak resin, and R¹² represents a hydrogen atom or a methyl group; or at least one phenolic hydroxyl group.

This means that glycidyloxy group and/or 2,3-epoxy-2-methylpropyloxy group, or a phenolic hydroxyl group of the novolak resin may remain. However, it is not preferable that the modified novolak resin (A) according to the present invention contains both the group represented by general formula (8) and the phenolic hydroxyl group. This may result in gelation.

The numbers of the groups represented by general formula (7), the groups represented by general formula (8) and the phenolic hydroxyl groups in a molecule may each be in the range of 0 to 19. Even if the numbers exceed the aforesaid range, satisfactory effects may be offered. However, since it is very difficult to control the molecular weight of a novolak resin having a larger number of phenolic rings, and at least one group represented by general formula (1) should be present, the upper limits of the numbers are each 19 in practice. The optimal numbers vary depending on the type of a pigment to be used, the specific surface area and particle size of the pigment, the presence or absence or the properties of a surface treating agent for the pigment, the type of a thermoplastic resin and the polarity of a dispersion medium to be used, etc. Therefore, the numbers should be each optimized in each case.

Further, the modified novolak resin (A) according to the present invention may be bridged intermolecularly or intramolecularly with a crosslinking group represented by general formula (9): 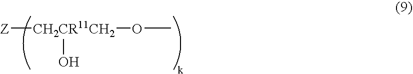
wherein the oxygen atom at the right end is derived from an oxygen atom of a phenolic hydroxyl group of the novolak resin in the same or different molecule thereof; Z represents a divalent to hexavalent organic group having 1 to 40 carbon atoms and, at its bonding end, an oxygen atom or a nitrogen atom; k represents an integer in the range of 2 to 6; and R¹¹ represents a hydrogen atom or a methyl group.

For substitution of active hydrogen atoms of the phenolic hydroxyl groups with the intermolecular or intramolecular crosslinking group represented by general formula (9), the phenolic hydroxyl groups are reacted with epichlorohydrin and/or β-methylepichlorohydrin, and then with a di- to hexa-functional carboxylic acid, amine (including a primary monoamine) or amino acid. Since a basic group formed by the reaction with the amine or amino acid tends to adversely affect on the charging property, it is better to avoid the use of the amine or amino acid. If the amine or amino acid is used, it is necessary to carefully determine the amount thereof.

Examples of specific polyfunctional carboxylic acids include aliphatic polycarboxylic acids such as succinic acid, maleic acid, itaconic acid, cyclohexanedicarboxylic acid, adipic acid, azelaic acid, sebacic acid, 1,10-decanedicarboxylic acid, dodecenylsuccinic acid, dimer acids, 3,6-endomethylenetetrahydrophthalic acid and 3,6-methylendomethylenetetrahydrophthalic acid; aromatic polycarboxylic acids such as phthalic acid, isophthalic acid, terephthalic acid, trimellitic acid, pyromellitic acid, benzophenonetetracarboxylic acid, ethylene glycol bistrimellitate and glycerol tristrimellitate.

Examples of specific polyfunctional amines include aliphatic polyamines such as ethylenediamine, diethylenetriamine, triethylenetetramine, tetraethylenepentamine, pentaethylenehexamine, propylenediamine, (dimethylamino)propylamine, (diethylamino)propylamine, hexamethylenediamine, hexamethylenetriamine, N,N-bis(aminopropyl)methylamine, isophoronediamine, norbornanediamine, diaminodicyclohexylmethane, N-(aminoethyl)pyperazine, N,N′-bis(aminoethyl)pyperazine, xylylenediamine and dimerdiamines; and aromatic polyamines such as melamine, benzoguanamine, m-phenylenediamine and diaminodiphenylmethane.

Polyether diamines, N-aminoethylethanolamine, so-called polyaminoamides and the like may also be used.

The formation of the crosslinking structure can alternatively be achieved by a reaction of the epoxy group with a primary amino group which is difunctional with respect to the epoxy group. In such a case, a primary monoamine as described above may be used. An amino acid such as leucine or threonine may also be used.

The aforesaid reaction can be conducted by heating at 60° to 160° C. in a suitable organic solvent as required in the presence of a catalyst such as an aliphatic tertiary amine, an aromatic tertiary amine or an ammonium salt of a tertiary amine as required. The reaction can be followed by measuring the molecular weight by way of GPC or by measuring the epoxy equivalent.

Since it is very difficult to control the molecular weight of a novolak resin having a large number of phenolic rings, the total number of the phenolic hydroxyl groups in a molecule of the modified novolak resin (the total number of non-substituted and substituted phenolic hydroxyl groups, hereinafter the same) is preferably not greater than 20.

Then the graft copolymer (B) according to the present invention will be described.

The graft copolymer (B) is prepared by the following method (I) or (II).

(I) 10 to 90% by mole of an ethylenic unsaturated monomer having an epoxy group represented by general formula (10): 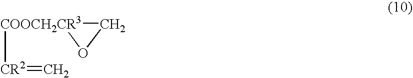
wherein R² and R³ each have the same definition as described above; and 10 to 90% by mole of at least one member selected from the group consisting of monomers represented by general formula (11): 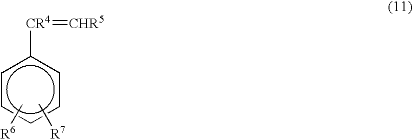
wherein R⁴, R⁵, R⁶ and R⁷ each have the same definition as described above, and monomers represented by general formula (12): 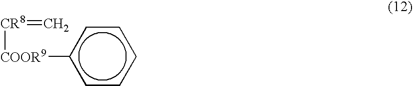
wherein R⁸ and R⁹ each have the same definition as described above; and as required, 0 to 80% by mole of an additional ethylenic unsaturated monomer having no functional group highly reactive to an epoxy group are polymerized with use of a radical polymerization initiator such as a peroxide or an azo compound by an ordinary method to provide a copolymer having epoxy groups. Then, the epoxy groups of the copolymer are reacted with a hydroxycarboxylic acid and as required, with a carboxylic acid or an amine.

(II) 10 to 90% by mole of a monomer represented by general formula (13): 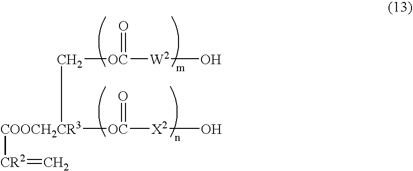
wherein R², R³, W² and X² each have the same definition as described above; and m and n are an integer of 1 to 30 and an integer of 0 to 30, respectively, and as required, a monomer represented by general formula (14): 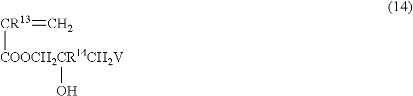
wherein V is a monovalent organic group having 1 to 20 carbon atoms and, at its bonding end, an oxygen atom or a nitrogen atom (excluding a group represented by general formula (15): 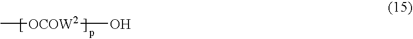
wherein W² and p each have the same definition as described above); and R¹³ and R¹⁴ are independently each a hydrogen atom or a methyl group; and 10 to 90% by mole of at least one member selected from the group consisting of monomers represented by general formula (11) and monomers represented by general formula (12); and 0 to 80% by mole of an additional ethylenic unsaturated monomer having no functional group highly reactive to an epoxy group are polymerized with use of a radical polymerization initiator such as a peroxide or an azo compound by an ordinary method.

In the method (I), the reaction of epoxy group of the copolymer with the carboxylic acid or amine described below to give the recurring unit represented by general formula (2) or the recurring unit represented by general formula (16): 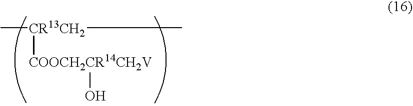
wherein V, R¹³ and R¹⁴ each have the same definition as described above is conducted by heating at 60° to 160° C. in a solvent as required, with use of a catalyst such as an aliphatic amine, an aromatic amine or an ammonium salt as required. In the method (II), the reaction of the epoxy group of the ethylenic unsaturated monomer represented by general formula (10) with a hydroxycarboxylic acid, and as required, with a carboxylic acid or an amine to give a monomer represented by general formula (13) or (14) is conducted under a similar condition.

In the recurring unit represented by general formula (3), examples of the halogen atom for R⁵ include chlorine atom and the like. Examples of the hydrocarbon group having 1 to 5 carbon atoms for R⁶ and R⁷ include alkyl groups such as methyl, ethyl, n-propyl, isopropyl, n-butyl, sec-butyl, t-butyl and pentyl. Examples of the alkoxy group having 1 to 5 carbon atoms for R⁶ and R⁷ include methoxy and butoxy. Examples of the aryloxy group having 6 to 10 carbon atoms for R⁶ and R⁷ include phenoxy and the like. Examples of the halogen atom for R⁶ and R⁷ include fluorine atom, chlorine atom and bromine atom.

Among the monomers used for preparation of the graft copolymer (B) according to the present invention, the monomers represented by general formula (11) are styrene and styrene derivatives. Examples of specific styrene derivatives include alkyl-substituted styrenes such as vinyltoluene, α-methylstyrene, dimethylstyrene, ethylstyrene, isopropylstyrene and t-butylstyrene; halogen-substituted styrenes such as chlorostyrene, dichlorostyrene, bromostyrene and fluorostyrene; alkoxy-substituted styrenes such as methoxystyrene and butoxystyrene; aryloxy-substituted styrenes such as phenoxystyrene; and β-chlorostyrene.

Examples of specific monomers represented by general formula (12) include benzyl (meth)acrylate and phenyl (meth)acrylate.

Examples of specific epoxy group-containing ethylenic unsaturated monomers represented by general formula (10) include glycidyl (meth)acrylate and 2,3-epoxy-2-methylpropyl (meth)acrylate.

As the additional ethylenic unsaturated monomer having no functional group highly reactive to an epoxy group to be optionally used, ethylenic unsaturated monomers which do not have any functional group highly reactive to an epoxy group, such as carboxyl group, phenolic hydroxyl group, primary amino group and secondary amino group, can be used. Examples thereof include alkyl esters of (meth)acrylic acid such as methyl (meth)acrylate, ethyl (meth)acrylate, propyl (meth)acrylate, butyl (meth)acrylate, cyclohexyl (meth)acrylate, 2-ethylhexyl (meth)acrylate, octyl (meth)acrylate, lauryl (meth)acrylate, dodecyl (meth)acrylate, cetyl (meth)acrylate, stearyl (meth)acrylate, behenyl (meth)acrylate and norbornyl (meth)acrylate; (meth)acrylates having a cyclic ether group such as tetrahydrofurfuryl (meth)acrylate; (meth)acrylates having a hydroxyl group on an aliphatic carbon such as 2-hydroxyethyl (meth)acrylate; (meth)acrylates having a tertiary amino group such as dimethylaminoethyl (meth)acrylate and diethylaminoethyl (meth)acrylate; vinyl ethers such as methyl vinyl ether, dodecyl vinyl ether and propenyl ether propylene carbonate; vinyl ethers having a hydroxyl group on an aliphatic carbon such as hydroxybutyl vinyl ether; and allyl esters of various acids such as allyl acetate.

Where the monomer represented by general formula (13) or (14) derived from reaction of the epoxy group of the ethylenic unsaturated monomer with a hydroxycarboxylic acid, and as required, a carboxylic acid or an amine is used to provide the graft copolymer, ethylenic unsaturated monomers having a functional group highly reactive to an epoxy group such as carboxyl group, phenolic hydroxyl group, primary amino group or secondary amino group can be used.

The recurring unit represented by formula (2) in the graft copolymer according to the present invention can be obtained by reaction of the epoxy group of a recurring unit derived from the epoxy-containing ethylenic unsaturated monomer presented by general formula (10), with a hydroxycarboxylic acid having 2 to 20 carbon atoms and optionally having an unsaturated bond and/or a branched structure, a mixture of such hydroxycarboxylic acids or a polycondensation product of one or more such hydroxycarboxylic acids.

Alternatively, the recurring unit represented by general formula (2) is derived from the monomer represented by general formula (13) obtained by reaction of the epoxy group of the epoxy-containing ethylenic unsaturated monomer represented by general formula (10) with a hydroxycarboxylic acid having 2 to 20 carbon atoms and optionally having an unsaturated bond and/or a branched structure, a mixture of such hydroxycarboxylic acids, or a polycondensation product of one or more such hydroxycarboxylic acids.

In general formula (2), W² and X² each represent a divalent hydrocarbon group having 1 to 19 carbon atoms and optionally having an unsaturated bond and/or a branched structure; and R² and R³ each independently represent a hydrogen atom or a methyl group.

In general formula (2), a group represented by general formula (15): 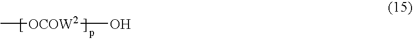
wherein W² and p each have the same definition as described above and a group represented by general formula (17): 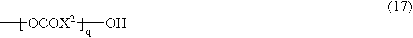
wherein X² and q each have the same definition as described above are derived from a hydroxycarboxylic acid having 2 to 20 carbon atoms and optionally having an unsaturated bond and/or a branched structure, or a mixture of such hydroxycarboxylic acids or a polycondensation product of one or more such hydroxycarboxylic acids.

Examples of specific hydroxycarboxylic acids include glycolic acid, lactic acid, hydroxybutyric acid, hydroxyvaleric acid, hydroxycaproic acid, hydroxycaprylic acid, hydroxycapric acid, hydroxylauric acid, hydroxymyristic acid, hydroxypalmitic acid, ricinolic acid and castor oil fatty acid and hydrogenated products of these unsaturated hydroxycarboxylic acids, and 12-hydroxystearic acid. Among these, hydroxycarboxylic acids having 12 to 20 carbon atoms, especially hydroxycarboxylic acids having 16 to 20 carbon atoms such as ricinolic acid and castor oil fatty acid, hydrogenated products thereof and 12-hydroxystearic acid are preferably used.

The repetition number p is an integer within the range of 1 to 30 and the repetition number q is an integer within the range of 0 to 30. The optimal repetition numbers vary depending on the type of a pigment to be used, the specific surface area and particle size of the pigment, the properties of a surface treating agent for the pigment, the type of a thermoplastic resin and the polarity of a dispersion medium, etc. Therefore, the repetition numbers should be optimized in each case. Generally, however, it is preferable that p or q≧2 and p+q≧2. If the repetition number p or q exceeds the aforesaid ranges, the dispersibility cannot be further improved.

The group represented by general formula (15) or (17) in general formula (2) can be formed, for example, by first carrying out polycondensation of a hydroxycarboxylic acid to give a polyester and then reacting its terminal carboxyl group with the aforesaid epoxy group, or, alternatively, by first reacting a carboxyl group of a hydroxycarboxylic acid with the aforesaid epoxy group and then carrying out further polycondensation of a hydroxycarboxylic acid.

The polycondensation of the hydroxycarboxylic acid can be conducted by heating the reaction system at 180° to 220° C. in the presence or absence of a catalyst such as p-toluenesulfonic acid, stannous octylate, dibutyltin diacetate or tetra-n-butyl titanate while generated water is removed with an azeotropic solvent such as toluene or xylene. The reaction can be followed by measuring the molecular weight by way of GPC or by measuring the acid value.

In the graft copolymer according to the present invention, the arrangement of respective recurring units may be random or regular.

The graft copolymer (B) according to the present invention must have the recurring unit represented by general formula (2) and at least one of the recurring unit represented by general formula (3) and the recurring unit represented by general formula (4).

In the graft copolymer (B), the content of the recurring unit represented by general formula (2) is an amount equivalent to at least 10% by mole, preferably 10 to 90% by mole, and the content of at least one recurring unit selected from the group consisting of the recurring units represented by general formulae (3) and (4) is an amount equivalent to at least 10% by mole, preferably 10 to 90% by mole.

That the recurring unit represented by general formula (2) is contained in an amount equivalent to at least 10% by mole means that when the graft copolymer is divided into recurring units derived from the ethylenic unsaturated monomers, the recurring unit represented by general formula (2) is contained in an amount of at least 10% by mole relative to 100% by mole of all recurring units, that is to say, when the graft copolymer is obtained by copolymerization of n molecules of ethylenic unsaturated monomers, the number of the recurring unit represented by general formula (2) in a molecule of the graft copolymer is at least 0.1×n. That at least one recurring unit selected from the group consisting of the recurring units represented by general formulae (3) and (4) is contained in an amount equivalent to at least 10% by mole means that when the graft copolymer is divided into recurring units derived from the ethylenic unsaturated monomers, at least one recurring unit selected from the group consisting of the recurring units represented by general formulae (3) and (4) is contained in an amount of at least 10% by mole relative to 100% by mole of all recurring units, that is to say, when the graft copolymer is obtained by copolymerization of n molecules of ethylenic unsaturated monomers, the number of at least one recurring unit selected from the group consisting of the recurring units represented by general formulae (3) and (4) in a molecule of the graft copolymer is at least 0.1×n.

If the content of either or both of the recurring units is less than the predetermined mole percentage, satisfactory dispersibility cannot be obtained. The optimal contents vary depending on the type of a pigment to be used, the specific surface area and particle size of the pigment, the presence or absence, or the properties of a surface treating agent for the pigment, and the polarity of a dispersion medium to be used, etc. Therefore the contents should be optimized in each case.

The graft copolymer (B) according to the present invention may further contain the recurring unit represented by general formula (16).

The recurring unit represented by general formula (16) can be formed by reaction of the epoxy group of the epoxy-containing ethylenic unsaturated monomer or the copolymer thereof, with a monocarboxylic acid or a monoamine. Since a basic group formed by the reaction with the monoamine tends to adversely affect on the charging property, it is better to avoid the use of the monoamine. If the monoamine is used, it is necessary to carefully determine the amount thereof.

Examples of specific monocarboxylic acids include saturated fatty acids such as acetic acid, propionic acid, butylic acid, caproic acid, caprylic acid, capric acid, lauric acid, myristic acid, palmitic acid and stearic acid; unsaturated fatty acids such as oleic acid, elaidic acid, linolic acid, linolenic acid, arachidonic acid and eleostearic acid; and hydrogenated products of these unsaturated fatty acids.

Examples of specific monoamines include aliphatic primary monoamines such as methylamine, ethylamine, propylamine, butylamine, amylamine, octylamine, dodecylamine, stearylamine and benzylamine; aromatic primary monoamines such as aniline and naphthylamine; secondary monoamines derived from N-monoalkylation of these aliphatic and aromatic primary monoamines; alkanolmonoamines having a primary or secondary amino group such as ethanolamine, N-monoalkylethanolamine and diethanolamine.

The graft copolymer (B) according to the present invention may have the recurring unit represented by general formula (18): 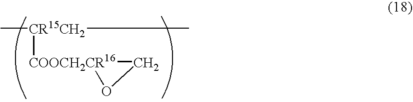
wherein R¹⁵ and R¹⁶ independently represent a hydrogen atom or a methyl group.

This means that glycidyloxy group and/or 2,3-epoxy-2-methylpropyloxy group introduced by the epoxy-containing ethylenic unsaturated monomer may remain.

The graft copolymer (B) according to the present invention preferably has a weight average molecular weight of 3,000 to 100,000. Even if the molecular weight is lower than 3,000, a satisfactory dispersibility may be ensured, but the control of the polymerization is difficult. On the other hand, if the molecular weight is higher than 100,000, a sufficient dispersibility cannot be ensured.

In the present invention, it is possible to obtain a liquid developer in which finer toner particles are dispersed with high dispersion stability or re-dispersibility by using the above-mentioned specific dispersant without lowering the volume resistivity of the liquid developer.

In the present invention, the amount of the dispersant is preferably 0.2 to 3.0 parts by weight in 100 parts by weight of the liquid developer. When it is less than 0.2 part by weight, the dispersibility and re-dispersibility of the toner particles tend to be degraded and when it exceeds 3.0 parts by weight, the electric resistance of the liquid developer tends to be lowered. The amount of the dispersant is more preferably 0.5 to 1.0 part by weight.

Further, if necessary, one or more additional components which can exist in liquid developers can also be added in the liquid developer of the present invention.

Then, the method for producing the liquid developer of the present invention is illustrated using the above-mentioned materials. The method illustrated below is one example of the preferred embodiments of the present invention, and the present invention is not limited to this.

Firstly, (1) a) a pigment as mentioned above and an acrylic-based thermoplastic resin as mentioned above are mixed under heating with a kneader such as a three-roll mill to obtain a resin/pigment dispersion. Then, a solvent (aromatic hydrocarbons such as toluene and benzene, ethers such as tetrahydrofuran, ketones such as methyl ethyl ketone and cyclohexanone, and esters such as ethyl acetate) capable of dissolving the acrylic-based thermoplastic resin is added to the resin/pigment dispersion to dissolve the resin, thereby yielding a pigment dispersed liquid. An electric insulating solvent in which a dispersant is dissolved is gradually added to the pigment dispersed liquid while stirring with a high speed shearing stirring apparatus to obtain a mixure liquid. Alternatively, b) a pigment as mentioned above, an acrylic-based thermoplastic resin as mentioned above and a solvent capable of dissolving the acrylic-based thermoplastic resin as mentioned above are mixed and the resulting mixture undergoes a wet dispersing treatment using a medium type dispersing machine such as an attritor, a ball mill or a sand mill, or a non medium type dispersing machine such as a high speed mixer or a high speed homogenizer, thereby yielding a pigment dispersed liquid. An electric insulating solvent in which a dispersant is dissolved is gradually added to the pigment dispersed liquid while stirring with a high speed shearing stirring apparatus to obtain a mixure liquid.

(2) The solvent added for dissolving the acrylic-based thermoplastic resin is distilled at a temperature lower than the softening point of the acrylic-based thermoplastic resin while stirring the mixture liquid obtained in the above-mentioned method a) or b) with a high speed shearing stirring apparatus, by which the resin is precipitated on the surface of the pigment particles to obtain a liquid developer. Further, if necessary, an electric insulating solvent is added so as to meet a required solid content, and a charge controlling agent and other additional components are added to obtain a liquid developer in accordance with the present invention.

The above-mentioned softening point means a temperature at which the acrylic-based thermoplastic resin heated begins to be softened. A method using an evaporator or the like is preferable as the method for distilling off the solvent used for dissolving the acrylic-based thermoplastic resin. Distillation at 30° to 60° C. under 50 to 100 kPa is preferable.

As the high speed shearing stirring apparatus, a device capable of applying shear on stirring, including a homogenizer, a homomixer and the like, can be utilized. There are various apparatues depending upon the number of revolutions, model and the like, and an appropriate apparatus in accordance with production manner may be used. In case of using a homogenizer, the number of revolutions is preferably 500 revolutions (rpm) or more.

The liquid developer of the present invention which contains the toner particles dispersed in the electric insulating solvent by the above-mentioned method is a liquid developer in which the toner particles have a small particle size and a narrow particle size distribution, and which has a low viscosity and can be highly solidified and is excellent in re-dispersibility and high speed developing property.

The present invention will be more fully described by way of Examples and Comparative Examples thereof. It is to be understood that the present invention is not limited to these Examples, and various changes and modifications may be made in the invention without departing from the spirit and scope thereof. The terms “parts” and “%” mean “parts by weight” and “% by weight” respectively, unless otherwise noticed.

Dispersant A

A mixture of 30 parts of an epoxy-modified novolak resin (Epikote 154 available from Yuka Shell Epoxy Co., Ltd.), 75 parts of a polyester obtained by polycondensation of 12-hydroxystearic acid and having an acid value of 30 and a weight average molecular weight 4,500, 35 parts of stearic acid and 0.2 part of tetraethylammonium bromide was placed into a reaction vessel and stirred at 130° to 150° C. for 3 hours under a current of nitrogen, and then the catalyst was filtered away under reduced pressure to afford a modified novolak resin (Dispersant A) having a weight average molecular weight of 8,000.

Dispersant B

A mixture of 100 parts of 12-hydroxystearic acid, 10 parts of xylene and 0.1 part of tetra-n-butyl titanate was placed into a reaction vessel and allowed to undergo a polycondensation at 180° to 200° C. under a current of nitrogen while generated water was removed by azeotropic distillation. When the acid value became a predetermined value, xylene was distilled off to afford a polyester of a pale brown polymer having an acid value of 33 and a weight average molecular weight of 4,400. In turn, 74.3 parts of the polyester and 25.7 parts of a copolymer of styrene and glycidyl methacrylate (contents: 80% by mole and 20% by mole, respectively) as an epoxy-containing copolymer were reacted at 130° to 150° C. in 40 parts of dimethylformamide as a solvent. When the amounts of remaining carboxyl groups and epoxy groups which were measured as the acid value and epoxy equivalent were reduced to measurable limits, the solvent was distilled off under reduced pressure to afford a graft copolymer (Dispersant B). The weight average molecular weight of the graft copolymer was 35,000 as measured by GPC.

Acrylic-Based Thermoplastic Resin 1

76.7 Parts of styrene (St), 14.7 parts of stearyl methacrylate (SMA), 8.6 parts of dimethylacrylamide (DMAA), 160 parts of toluene and 1.5 parts of azobisisobutyronitrile as an initiator were mixed and allowed to undergo radical polymerization at 80° C. for 10 hours. The obtained resin solution was further heated at 150° C. under a reduced pressure of 70 cmHg for 8 hours to distill off the toluene, unreacted monomers and low molecular weight oligomers, yielding Acrylic-based thermoplastic resin 1. The resin obtained had a composition of St:SMA:DMAA=85:5:10 by mole, a weight average molecular weight of 45,800, a melting point of 92° C. and a degree of swelling of 0.39 g.

The degree of swelling was measured as follows: 1 g of Acrylic-based thermoplastic resin 1 was added to 20 g of Isopar H (manufactured by Exxon Mobil Chemical Corporation) and tetrahydrofuran was added until Acrylic-based thermoplastic resin 1 was dissolved. Then the tetrahydrofuran was distilled off under a reduced pressure to precipitate Acrylic-based thermoplastic resin 1. By use of Multipurpose High-speed Refrigerated Centrifuge 6700 (manufactured by Kabushiki Kaisha Kubota Seisakusho), the liquid containing the precipitated resin was centrifuged at revolutions of 4,300 rpm (3,000 G) with angle rotor: RA-6 for 30 minutes to sediment Acrylic-based thermoplastic resin 1. The supernatant was discarded and the precipitate was taken out. The weight of the precipitate was measured and the degree of swelling was determined according to the following equation:
Degree of swelling=[Weight of precipitate−Weight (1 g) of Acrylic-based thermoplastic resin 1]
Acrylic-Based Thermoplastic Resin 2

77.5 Parts of styrene (St), 17.0 parts of stearyl methacrylate (SMA), 11 parts of hydroxyethyl methacrylate (HEMA), 160 parts of toluene and 1.5 parts of azobisisobutyronitrile as an initiator were mixed and allowed to undergo radical polymerization at 80° C. for 10 hours. The obtained resin solution was further heated at 150° C. under a reduced pressure of 70 cmHg for 8 hours to distill off the toluene, unreacted monomers and low molecular weight oligomers, yielding Acrylic-based thermoplastic resin 2. The resin obtained had a composition of St:SMA:HEMA=84:6:10 by mole, a weight average molecular weight of 50,200, a melting point of 90° C. and a degree of swelling of 0.45 g.

The degree of swelling was measured as follows: 1 g of Acrylic-based thermoplastic resin 2 was added to 20 g of Isopar H (manufactured by Exxon Mobil Chemical Corporation) and tetrahydrofuran was added until Acrylic-based thermoplastic resin 2 was dissolved. Then the tetrahydrofuran was distilled off under a reduced pressure to precipitate Acrylic-based thermoplastic resin 2. By use of Multipurpose High-speed Refrigerated Centrifuge 6700 (manufactured by Kabushiki Kaisha Kubota Seisakusho), the liquid containing the precipitated resin was centrifuged at revolutions of 4,300 rpm (3,000 G) with angle rotor: RA-6 for 30 minutes to sediment Acrylic-based thermoplastic resin 2. The supernatant was discarded and the precipitate was taken out. The weight of the precipitate was measured and the degree of swelling was determined according to the following equation:
Degree of swelling=[Weight of precipitate−Weight (1 g) of Acrylic-based thermoplastic resin 2]
Acrylic-Based Thermoplastic Resin 3

57.4 Parts of styrene (St), 37.3 parts of stearyl methacrylate (SMA), 8.9 parts of hydroxyethyl methacrylate (HEMA), 160 parts of toluene and 1.5 parts of azobisisobutyronitrile as an initiator were mixed and allowed to undergo radical polymerization at 80° C. for 10 hours. The obtained resin solution was further heated at 150° C. under a reduced pressure of 70 cmHg for 8 hours to distill off the toluene, unreacted monomers and low molecular weight oligomers, yielding Acrylic-based thermoplastic resin 3. The resin obtained had a composition of St:SMA:HEMA=70:20:10 by mole, a weight average molecular weight of 49,900, a melting point of 70° C. and a degree of swelling of 2.5 g.

The degree of swelling was measured as follows: 1 g of Acrylic-based thermoplastic resin 3 was added to 20 g of Isopar H (manufactured by Exxon Mobil Chemical Corporation) and tetrahydrofuran was added until Acrylic-based thermoplastic resin 3 was dissolved. Then the tetrahydrofuran was distilled off under a reduced pressure to precipitate Acrylic-based thermoplastic resin 3. By use of Multipurpose High-speed Refrigerated Centrifuge 6700 (manufactured by Kabushiki Kaisha Kubota Seisakusho), the liquid containing the precipitated resin was centrifuged at revolutions of 4,300 rpm (3,000 G) with angle rotor: RA-6 for 30 minutes to sediment Acrylic-based thermoplastic resin 3. The supernatant was discarded and the precipitate was taken out. The weight of the precipitate was measured and the degree of swelling was determined according to the following equation:
Degree of swelling=[Weight of precipitate−Weight (1 g) of Acrylic-based thermoplastic resin 3]
Partially Hydrolyzed Product of Ethylene-Vinyl Acetate Copolymer

DUMILAN D219 (manufactured by Takeda Chemical Industries, Ltd.) was used as a partially hydrolyzed product of an ethylene-vinyl acetate copolymer. The degree of swelling was 6.8 g.

The degree of swelling was measured as follows: 1 g of DUMILAN D219 was added to 20 g of Isopar H (manufactured by Exxon Mobil Chemical Corporation) and tetrahydrofuran was added until DUMILAN D219 was dissolved. Then the tetrahydrofuran was distilled off under a reduced pressure to precipitate DUMILAN D219. By use of Multipurpose High-speed Refrigerated Centrifuge 6700 (manufactured by Kabushiki Kaisha Kubota Seisakusho), the liquid containing the precipitated resin was centrifuged at revolutions of 4,300 rpm (3,000 G) with angle rotor: RA-6 for 30 minutes to sediment DUMILAN D219. The supernatant was discarded and the precipitate was taken out. The weight of the precipitate was measured and the degree of swelling was determined according to the following equation:
Degree of swelling=[Weight of precipitate−Weight (1 g) of DUMILAN D219]

### EXAMPLE 1

30 Parts of carbon black (Mogul L, manufactured by Cabot Corporation) and 90 parts of Acrylic-based thermoplastic resin 1 were kneaded at 130° C. using three heating rolls, and the kneaded product was finely pulverized. 12 Parts of the kneaded product was dispersed/dissolved into 60 parts of tetrahydrofuran using a homogenizer (POLYTRON, manufactured by KINEMATICA AG). Then a solution in which 0.2 part of Dispersant A was dissolved in 88 parts of Isopar H was added dropwise to the dispersion with stirring (3,000 rpm) in the homogenizer. After completion of the dropwise addition, the tetrahydrofuran was distilled off at 40° C. under a reduced pressure of 40 cmHg using the homogenizer. Finally 0.1 part of zirconium naphthenate was added as a charge controlling agent and stirred to give Liquid developer 1 having a solid content of 12%.

### EXAMPLE 2

30 Parts of carbon black (Mogul L, manufactured by Cabot Corporation) and 90 parts of Acrylic-based thermoplastic resin 2 were kneaded at 130° C. using three heating rolls, and the kneaded product was finely pulverized. 12 Parts of the kneaded product was dispersed/dissolved into 60 parts of tetrahydrofuran using a homogenizer (POLYTRON). Then a solution in which 0.2 part of Dispersant A was dissolved in 88 parts of Isopar H was added dropwise to the dispersion with stirring (3,000 rpm) in the homogenizer. After completion of the dropwise addition, the tetrahydrofuran was distilled off at 40° C. under a reduced pressure of 40 cmHg using the homogenizer. Finally 0.1 part of zirconium naphthenate was added as a charge controlling agent and stirred to give Liquid developer 2 having a solid content of 12%.

### EXAMPLE 3

30 Parts of carbon black (Mogul L, manufactured by Cabot Corporation) and 90 parts of Acrylic-based thermoplastic resin 2 were kneaded at 130° C. using three heating rolls, and the kneaded product was finely pulverized. 12 Parts of the kneaded product was dispersed/dissolved into 60 parts of tetrahydrofuran using a homogenizer (POLYTRON). Then a solution in which 0.2 part of Dispersant B was dissolved in 88 parts of Isopar H was added dropwise to the dispersion with stirring (3,000 rpm) in the homogenizer. After completion of the dropwise addition, the tetrahydrofuran was distilled off at 40° C. under a reduced pressure of 40 cmHg using the homogenizer. Finally 0.1 part of zirconium naphthenate was added as a charge controlling agent and stirred to give Liquid developer 3 having a solid content of 12%.

### COMPARATIVE EXAMPLE 1

30 Parts of carbon black (Mogul L, manufactured by Cabot Corporation) and 90 parts of Acrylic-based thermoplastic resin 1 were kneaded at 130° C. using three heating rolls, and the kneaded product was finely pulverized. 12 Parts of the kneaded product was dispersed/dissolved into 60 parts of tetrahydrofuran using a homogenizer (POLYTRON). Then 88 parts of Isopar H was added dropwise to the dispersion with stirring (3,000 rpm) in the homogenizer. After completion of the dropwise addition, the tetrahydrofuran was distilled off at 40° C. under a reduced pressure of 40 cmHg using the homogenizer. Finally 0.1 part of zirconium naphthenate was added as a charge controlling agent and stirred to give Liquid developer 4 having a solid content of 12%.

### COMPARATIVE EXAMPLE 2

30 Parts of carbon black (Mogul L, manufactured by Cabot Corporation) and 90 parts of DUMILAN D219 (a partially hydrolyzed product of an ethylene-vinyl acetate copolymer manufactured by Takeda Chemical Industries, Ltd.) were kneaded at 130° C. using three heating rolls, and the kneaded product was finely pulverized. 12 Parts of the kneaded product was dispersed/dissolved into 70 parts of tetrahydrofuran using a homogenizer (POLYTRON). Then 88 parts of Isopar H was added dropwise to the dispersion with stirring (3,000 rpm) at 45° C. in the homogenizer. After completion of the dropwise addition, the tetrahydrofuran was distilled off at 40° C. under a reduced pressure of 40 cmHg using the homogenizer. Finally 0.1 part of zirconium naphthenate was added as a charge controlling agent and stirred to give Liquid developer 5 having a solid content of 12%.

### COMPARATIVE EXAMPLE 3

Liquid developer 5 was diluted with Isopar H to obtain Liquid developer 6 having a solid content of 5% and a viscosity of 5.1 mPa·s.

### COMPARATIVE EXAMPLE 4

30 Parts of carbon black (Mogul L, manufactured by Cabot Corporation) and 90 parts of Acrylic-based thermoplastic resin 3 were kneaded at 130° C. using three heating rolls, and the kneaded product was finely pulverized. 12 Parts of the kneaded product was dispersed/dissolved into 70 parts of tetrahydrofuran using a homogenizer (POLYTRON). Then 88 parts of Isopar H was added dropwise to the dispersion with stirring (3,000 rpm) at 45° C. in the homogenizer. After completion of the dropwise addition, the tetrahydrofuran was distilled off at 40° C. under a reduced pressure of 40 cmHg using the homogenizer. Finally 0.1 part of zirconium naphthenate was added as a charge controlling agent and stirred to give Liquid developer 7 having a solid content of 12%.

[Evaluation]

Each of the liquid developers obtained in Examples 1 to 3 and Comparative Examples 1 to 4 was evaluated for the below-mentioned items. The results are shown in Tables 1 and 2.

ξ Potential

ξ potential was measured for each of the liquid developers at an electric field strength of 114 V/cm using a laser ξ potentiometer LEZA-600 (manufactured by Otsuka Electronics Co., Ltd.).

Volume Resistivity

Volume resistivity was measured for each of the liquid developers using a micro current meter R8340 (Advantest Corporation).

Average Particle Size

The average particle size of toner particles was measured for each of the liquid developers using Centrifugal/Sedimentation Particle Size Distribution Analyzer manufactured by HORIBA, Ltd.

Viscosity

Viscosity at 25° C. was measured for each of the liquid developers as viscosity after 60 seconds with an E type viscometer (50 rpm). Since Liquid developer 5 of Comparative Example 2 and Liquid developer 7 of Comparative Example 4 were highly viscous, measurement was carried out at 2.5 rpm.

Re-Dispersibility (Dispersion Stability)

Each of the liquid developers was allowed to stand at 25° C. for one month. After stirring, the particle size distribution of toner particles was measured using the particle size distribution analyzer. The liquid developer of which the particle size distribution was hardly changed as compared with that before allowing to stand was graded “2” and the liquid developer of which the particle size distribution was changed as compared with that before allowing to stand was graded “1”.

Developing Property

An electrostatic pattern was formed on an electrostatic recording paper for each of the liquid developers with a surface charge of 150 to 500 V and development was carried out at a process speed of 400 mm/s and a developing roller speed of 800 mm/s. The liquid developer which gave a good image was graded “2” and the liquid developer which gave a poor image was graded “1”.

TABLE 1

| | ζ | Volume | Average | |
|---|---|---|---|---|
| | Potential | resistivity | particle | Viscosity |
| | (mV) | (Ω · cm) | size (μm) | (mPa · s) |
| Ex. 1 | +120 | 3.4 × 10¹⁰ | 2.2 | 3.1 |
| Ex. 2 | +111 | 1.3 × 10¹⁰ | 2.1 | 3.0 |
| Ex. 3 | +110 | 5.0 × 10¹⁰ | 2.3 | 3.2 |
| Com. Ex. 1 | +121 | 1.1 × 10¹¹ | 3.2 | 4.5 |
| Com. Ex. 2 | +109 | 4.0 × 10¹⁰ | 1.8 | 10.0 |
| Com. Ex. 3 | — | — | — | 5.1 |
| Com. Ex. 4 | +70 | 5.2 × 10¹⁰ | 1.6 | 19.0 |

TABLE 2

| | Re-dispersibility | Developing property |
|---|---|---|
| Ex. 1 | 2 | 2 |
| Ex. 2 | 2 | 2 |
| Ex. 3 | 2 | 2 |
| Com. Ex. 1 | 1 | 1 |
| Com. Ex. 2 | 2 | 1 (fogging occurred in non-image |
| | | portion due to high viscosity) |
| Com. Ex. 3 | 2 | 1 (density unevenness occurred) |
| Com. Ex. 4 | 1 | 1 (fogging occurred over the entire |
| | | surface, resulting in failure to |
| | | produce an image) |

The liquid developer of the present invention is a liquid developer in which the toner particles dispersed in a solvent which is electric insulating and has no solubility against the acrylic-based thermoplastic resin have a small particle size and a narrow particle size distribution and are excellent in re-dispersibility and in developing properties. Further, since the liquid developer of the present invention is low in viscosity, it can be highly solidified.

What is claimed is:

1. A method for preparing a liquid developer composition comprising a pigment, an acrylic-based thermoplastic resin, an electric insulating solvent and a dispersant, the acrylic-based thermoplastic resin having a degree of swelling of less than 0.5 g against the electric insulating solvent, the dispersant comprising at least one of modified novolak resin (A) and copolymer (B), wherein the method comprises the steps of:
mixing the pigment and the acrylic-based thermoplastic resin having a degree of swelling of less than 0.5 g against the electric insulating solvent under heating to obtain a resin/pigment dispersion;
adding a solvent capable of dissolving the acrylic-based thermoplastic resin to the resin/pigment dispersion to dissolve the acrylic-based thermoplastic resin, thereby yielding a pigment dispersed liquid;
gradually adding the electric insulating solvent to the pigment dispersed liquid while stirring with a high speed shearing stirring apparatus to obtain a mixture liquid, the electric insulating solvent containing the dispersant dissolved therein; and
distilling off the solvent added for dissolving the acrylic-based thermoplastic resin while stirring the mixture liquid with the high speed shearing stirring apparatus, thereby precipitating the acrylic-based thermoplastic resin on the surface of the pigment particles, wherein the modified novolak resin (A) comprises a modified novolak resin containing in its molecule an aromatic ring derived from a novolak resin and at least one group represented by general formula (1) obtained by ring opening of an epoxy group with a carboxyl group derived from a hydroxycarboxylic acid, 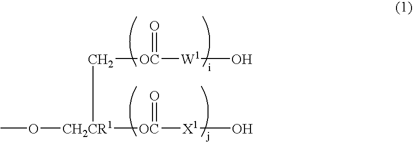
wherein the oxygen atom at the left end is derived from an oxygen atom contained in a phenolic hydroxyl group of the novolak resin; W¹ and X¹ represent independently a divalent hydrocarbon group having 1 to 19 carbon atoms; i and j represent independently integers of i=1 to 30 and j=0 to 30; and R¹ represents a hydrogen atom or a methyl group, and
wherein copolymer (B) comprises a copolymer having a weight average molecular weight of 3,000 to 100,000 which contains an amount equivalent to at least 10% by mole of a recurring unit represented by general formula (2) and an amount equivalent to at least 10% by mole of at least one recurring unit selected from the group consisting of recurring units represented by general formula (3) and general formula (4), 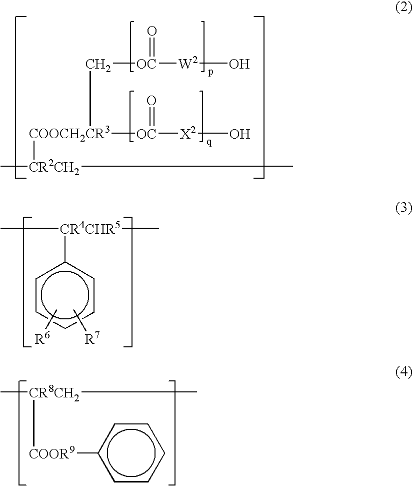
wherein W² and X² represent independently a divalent hydrocarbon group having 1 to 19 carbon atoms; p and q represent independently integers of p=1 to 30 and q=0 to 30; R², R³ and R⁴ represent independently a hydrogen atom or a methyl group; R⁵ represents a hydrogen atom or a halogen atom; R⁶ and R⁷ represent independently a hydrogen atom, a hydrocarbon group having 1 to 5 carbon atoms, an alkoxy group having 1 to 5 carbon atoms, an aryloxy group having 6 to 10 carbon atoms or a halogen atom; R⁸ represents a hydrogen atom or a methyl group; and R⁹ represents a direct bond or a methylene group.

2. A method for preparing a liquid developer composition comprising a pigment, an acrylic-based thermoplastic resin, an electric insulating solvent and a dispersant, the acrylic-based thermoplastic resin having a degree of swelling of less than 0.5 g against the electric insulating solvent, the dispersant comprising at least one of modified novolak resin (A) and copolymer (B), wherein the method comprises the steps of:
mixing the pigment and the acrylic-based thermoplastic resin having a degree of swelling of less than 0.5 g against the electric insulating solvent, and a solvent capable of dissolving the acrylic-based thermoplastic resin;
subject the resulting mixture to a dispersing treatment using a dispersing apparatus, thereby yielding a pigment dispersed liquid;
gradually adding the electric insulating solvent to the pigment dispersed liquid while stirring with a high speed shearing stirring apparatus to obtain a mixture liquid, the electric insulating solvent containing the dispersant dissolved therein; and
distilling off the solvent added for dissolving the acrylic-based thermoplastic resin while stirring the mixture liquid with the high speed shearing stirring apparatus, thereby precipitating the acrylic-based thermoplastic resin on the surface of the pigment particles,
wherein the modified novolak resin (A) comprises a modified novolak resin containing in its molecule an aromatic ring derived from a novolak resin and at least one group represented by general formula (1) obtained by ring opening of an epoxy group with a carboxyl group derived from a hydroxycarboxylic acid, 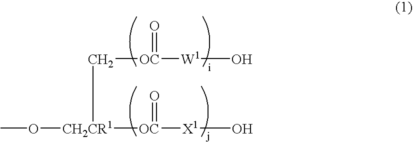
wherein the oxygen atom at the left end is derived from an oxygen atom contained in a phenolic hydroxyl group of the novolak resin; W¹ and X¹ represent independently a divalent hydrocarbon group having 1 to 19 carbon atoms; i and j represent independently integers of i=1 to 30 and j=0 to 30; and R¹ represents a hydrogen atom or a methyl group, and
wherein copolymer (B) comprises a copolymer having a weight average molecular weight of 3,000 to 100,000 which contains an amount equivalent to at least 10% by mole of a recurring unit represented by general formula (2) and an amount equivalent to at least 10% by mole of at least one recurring unit selected from the group consisting of recurring units represented by general formula (3) and general formula (4), 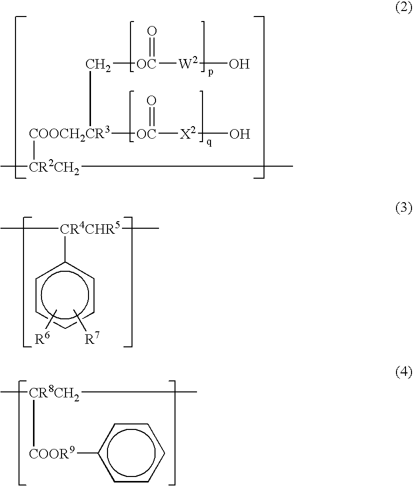
wherein W² and X² represent independently a divalent hydrocarbon group having 1 to 19 carbon atoms; p and q represent independently integers of p=1 to 30 and q=0 to 30; R², R³ and R⁴ represent independently a hydrogen atom or a methyl group; R⁵ represents a hydrogen atom or a halogen atom; R⁶ and R⁷ represent independently a hydrogen atom, a hydrocarbon group having 1 to 5 carbon atoms, an alkoxy group having 1 to 5 carbon atoms, an aryloxy group having 6 to 10 carbon atoms or a halogen atom; R⁸ represents a hydrogen atom or a methyl group; and R⁹ represents a direct bond or a methylene group.

3. The method of claim 1, wherein the high speed shearing stirring apparatus is a homogenizer.

4. The method of claim 3, wherein the homogenizer is operated at a rotation speed of 500 or more rpm.

5. The method of claim 2, wherein the high speed shearing stirring apparatus is a homogenizer.

6. The method of claim 5, wherein the homogenizer is operated at a rotation speed of 500 or more rpm.

7. The method of claim 1, wherein the resulting liquid developer has a content of toner particles of 50% by weight or less.

8. The method of claim 2, wherein the resulting liquid developer has a content of toner particles of 50% by weight or less.
